(19) United States
(12) Patent Application Publication
(10) Pub. No.: US 2010/0146559 A1
(43) Pub. Date: Jun. 10, 2010

(54) FEEDBACK BASED BROADCAST SCHEDULING

(75) Inventors: JANGWON LEE, San Diego, CA (US); An Mei Chen, San Diego, CA (US)

Correspondence Address: QUALCOMM INCORPORATED, 5775 MOREHOUSE DR., SAN DIEGO, CA, 92121, US

(73) Assignee: QUALCOM Incorporated, San Diego, CA (US)

(21) Appl. No.: 12/332,226

(22) Filed: Dec. 10, 2008

(51) Int. Cl. H04N 5/445; H04N 7/173

(52) U.S. Cl. 725/61; 725/120

(57) ABSTRACT

Systems and methodologies are described that facilitated generating a broadcast schedule of content based on user feedback. Users can provide feedback such as ratings, interest (e.g., like or dislike), comments, reviews, critiques and so on regarding content available on a media distribution system. The feedback can be utilized to determine a schedule or order of content that is delivered via a broadcast mechanism. In addition, users can supply contemporaneous feedback during broadcast. Contemporaneous feedback can be employed to enable dynamic adjustment and/or reconfigurations of the broadcast schedule.

### BACKGROUND

Communication networks have been designed to deliver content to recipients. Further, communication networks can employ a variety of delivery mechanisms to deliver content. For example, one type of communication network comprises a unicast system, which delivers content to on recipient at a time (e.g., on a one-to-one basis). Because of this one-to-one nature, a user of a unicast system can request to receive content of interest to that user only. When desiring to communicate a single piece of content to a large number of recipients, however, unicast system are relatively inefficient. For example, in a unicast system, the delivery of identical content to multiple endpoints is resource intensive. Each endpoint redundantly requests same content and reserves a predetermined amount of bandwidth, thereby consuming valuable network resource and limiting scalability. Unicast transmissions involve sending information to a single destination. While such unicast transmission can be obtained by multiple receivers, generally only the addressed receiver (e.g., the single destination) digests the information. Information is directed over communication links in a network required to achieve delivery, limiting receivers obtaining the message and resources consumed.

Multicast systems are communication networks which transmit information to multiple recipients concurrently. Multicast delivery technologies can provide cost effective delivery of content usable by a large number of network endpoints. Pursuant to an illustration, multicast delivery can be implemented on a unicast based network through utilization of network addressing mechanisms that enable delivery of information to a group of destinations simultaneously. Multicast delivery mechanisms can strive for efficient through delivery of information over a link of a network only once. For instance, copies can be created where links to multiple destinations split (e.g., network switches, routers, etc.). In one example, multicast delivery mechanisms can be employed for streaming media (e.g., Internet television, Internet radio, video streaming, audio streaming, etc.), where media is streamed to requested users within a same time frame. Further, a broadcast delivery mechanism can be employed. In broadcast, information is transmitted to all units (e.g., devices, terminals, receivers, etc.) capable of receiving the transmission. A media-distribution system can employ unicast, multicast, broadcast or a combination thereof. A program guide can be provided that describes a delivery schedule of available from one or more content providers.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with generating a broadcast schedule of content based on user feedback. Users can provide feedback such as ratings, interest (e.g., like or dislike), comments, reviews, critiques and so on regarding content available on a media distribution system. The feedback can be utilized to determine a schedule or order of content that is delivered via a broadcast mechanism. In addition, users can supply contemporaneous feedback during broadcast. Contemporaneous feedback can be employed to enable dynamic adjustment and/or reconfigurations of the broadcast schedule.

According to an aspect, a method that facilitates automatic content scheduling is provided herein. The method can comprise obtaining feedback from at least one user, the feedback relates to one or more content available for broadcast. The method can also include generating a broadcast schedule of content based at least in part on the obtained feedback. In addition, the method can comprise delivering content in accordance with the generated schedule.

Another aspect relates to an apparatus that facilitates content schedule generation. The apparatus can include a memory that retains instructions related to obtaining feedback from at least one user such that the feedback relates to one or more content available for broadcast, generating a broadcast schedule of content based at least in part on the obtained feedback and delivering content in accordance with the generated schedule. The apparatus can also include a processor, coupled to the memory, configured to execute the instructions retained in the memory.

Yet another aspect relates to an apparatus that facilitates automatic generation of content broadcast schedules. The apparatus can include means for obtaining feedback from at least one user, the feedback relates to one or more content available for broadcast. The apparatus can further comprise means for generating a broadcast schedule of content based at least in part on the obtained feedback. In addition, the apparatus can comprise means for delivering content in accordance with the generated schedule.

Still yet another aspect relates to a computer program product that can have a computer-readable medium. The computer-readable medium can comprise code for causing a computer to obtain feedback from at least one user, the feedback relates to one or more content available for broadcast. The computer-readable medium can also include code for causing the computer to generate a broadcast schedule of content based at least in part on the obtained feedback. In addition, the computer-readable medium can comprise code for causing the computer to deliver content in accordance with the generated schedule.

Another aspect relates to at least one processor. The at least one processor can be configured to obtain feedback from at least one user, the feedback relates to one or more content available for broadcast. The at least one processor can also be configured to generate a broadcast schedule of content based at least in part on the obtained feedback. In addition, the at least one processor can be configured to deliver content in accordance with the generated schedule.

In accordance with another aspect, a method is described that facilitates influence on a broadcast schedule. The method can comprise obtaining a list of content available for broadcast by a distributor. The method can also include supplying feedback related to individual content items included on the list of content. In addition, the method can comprise receiving a broadcast stream of content according to a schedule determined based upon the supplied feedback.

Another aspect relates to an apparatus that facilitates content scheduling. The apparatus can comprise a user interface that presents a list of content available for broadcast by a distributor, wherein the user interface further collects feedback from at least one user. The apparatus can also include a feedback provider that transmits the collected feedback to the distributor. In addition, the apparatus can comprise a broadcast receiver that receives a broadcasted stream of content delivered in accordance with a schedule generated based upon the transmitted feedback.

Yet another aspect relates to an apparatus that facilitates content scheduling. The apparatus can include means for obtaining a list of content available for broadcast by a distributor. The apparatus can also comprise means for supplying feedback related to individual content items included on the list of content. In addition, the apparatus can include means for receiving a broadcast stream of content according to a schedule determined based upon the supplied feedback.

Still another aspect relates to a computer program product having a computer-readable medium. The computer-readable medium can comprise code for causing a computer to obtain list of content available for broadcast by a distributor. The computer-readable medium can also include code for causing the computer to supply feedback related to individual content items included on the list of content. In addition, the computer-readable medium can comprise code for causing the computer to receive a broadcast stream of content according to a schedule determined based upon the supplied feedback.

Another aspect relates to at least one processor configured to facilitate content scheduling. The at least one processor can comprise a first module for obtaining a list of content available for broadcast by a distributor. The at least one processor can also include a second module for supplying feedback related to individual content items included on the list of content. In addition, the at least one processor can comprise a third module for receiving a broadcast stream of content according to a schedule determined based upon the supplied feedback.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of an example system that facilitates content delivery to a plurality of clients in accordance with an aspect of the subject disclosure.

FIG. 2 is an illustration of an example system that facilitates automatic generation of a broadcast schedule of content.

FIG. 3 is an illustration of an example system that generates broadcast schedules based on user feedback and includes detailed media distributor.

FIG. 4 is an illustration of an example system that facilitates providing feedback to a media distributor and includes a detailed media device.

FIG. 5 is an illustration of an example system that facilitates adjusting broadcasts based upon contemporaneous feedback according to an aspect of the subject disclosure.

FIG. 6 is an illustration of a example system that employs intelligence to automatically generate broadcast scheduled based on supplied feedback.

FIG. 7 is an illustration of an example methodology that facilitates generating a schedule of broadcast programs according to obtained feedback.

FIG. 8 is an illustration of an example methodology that facilitates receiving a broadcast determined from supplied feedback.

FIG. 9 is an illustration of an example methodology that facilitates dynamically altering a broadcast schedule according to contemporaneous information.

FIG. 10 is an illustration of an example system that generates broadcast schedules according to user feedback.

FIG. 11 is an illustration of an example system that enables feedback to be supplied determines a broadcast schedule.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspects(s) can be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a terminal, which can be a wired terminal or a wireless terminal. A terminal can also be called a system, device, apparatus, subscriber unit, subscriber station, mobile station, mobile, mobile device, remote station, remote terminal, access terminal, user terminal, communications, device, wireless communication device, user agent, user device, or user equipment (UE). A wireless terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with wireless terminal(s) and can also be referred to as an access point, NodeB, evolved NodeB (eNodeB or eNB), base transceiver station (BTS) or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

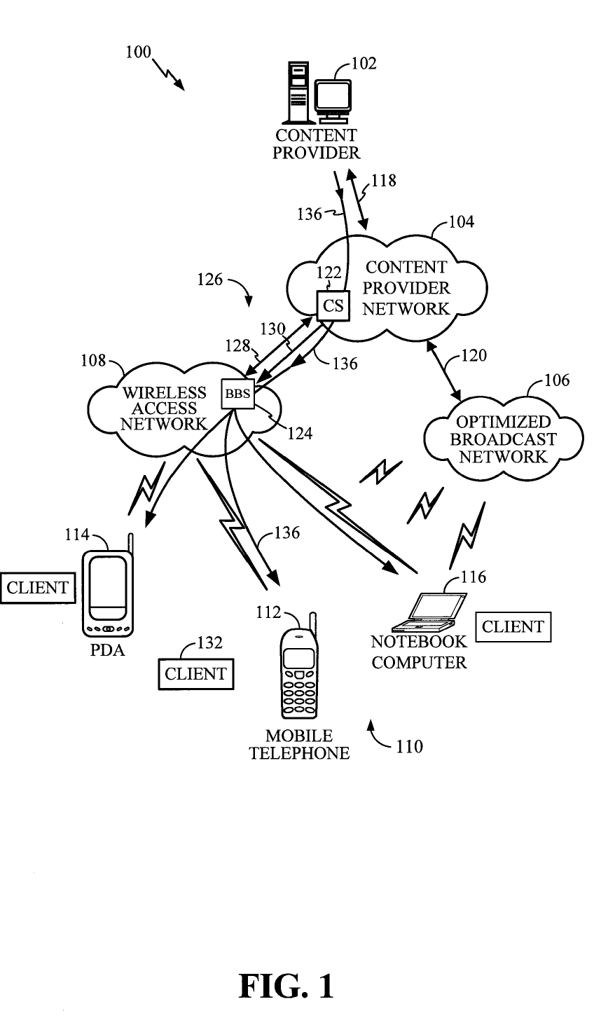

Turning now to FIG. 1, a system 100 is illustrated that enables transport of multimedia content flows across a variety of networks. For example, system 100 can deliver or transport content via a wireless communications network. In addition, system 100 can employ other communication or broadcast networks to deliver content. For instance, a cable television provider, a digital television provider, a satellite television provider, an over-the-air television provider, an over-the-air radio provider, a satellite radio provider or the like can be utilized to deliver multimedia content. Further, it is to be appreciated that data networks such the Internet, an intranet, a local area network, a wide area network can be employed to deliver and/or stream content in accordance with an aspect of the subject disclosure.

Pursuant to an illustrative embodiment, the system 100 can comprise a content provider (CP) 102, a content provider network 104, an optimized broadcast network 106, and a wireless access network 108. The network 100 also includes devices 110 that can comprise a mobile telephone 112, a personal digital assistance (PDA) 114, and a notebook computer 116. The devices 110 illustrate just some of the devices that are suitable for use in one or more embodiments of the transport system. It should be noted that although three devices are shown in FIG. 1, virtually any number of devices, or types of devices are suitable for use in the transport system. For instance, utilizing a broadcast delivery mechanism can enable a variety of devices to operate in system 100 provided the devices are capable of attaining the broadcast signal.

The content provider 102 operates to provide content for distribution to users in the system 100. The content can comprise video, audio, multimedia content, clips, real-time and non real-time content, scripts, programs, data or any other type of suitable content. The content provider 102 can provide the content to the content provider network 104 for distribution. For example the content provider 102 communicates with the content provider network 104 via a communication link 118, which comprises any suitable type of wired and/or wireless communication link.

The content provider network 104 can comprise a combination of wired and wireless networks that operate to distribute content for delivery to users. The content provider network 104 communicates with the optimized broadcast network 106 via the link 120. The link 120 comprises a suitable type of wired and/or wireless communication link. The optimized broadcast network 106 can further comprise a combination of wired and/or wireless networks designed to broadcast high quality content. For example, the optimized broadcast network 106 can be a specialized proprietary network that has been optimized to deliver high quality content to selected devices over a plurality of optimized communication channels.

In one or more embodiments, the transport system operates to deliver content from the content provider 102 for distribution to a content server (CS) 122 at the content provider network 104 that operates to communicate with a broadcast base station (BBS) 124 at the wireless access network. The CS 122 and the BBS 124 communicate using one or more embodiments of a transport interface 126 that allows the content provider network 104 to deliver content in the form of content flows to the wireless access network 108 for broadcast/multicast to the devices 110. The transport interface 126 comprises a control interface 128 and a bearer channel 130. The control interface 128 operates to allow the CS 122 to add, change, cancel, or otherwise modify contents flows that flow from the content provider network 104 to the wireless access network 108. The bearer channel 130 operates to transport the content flows from the content provider network 104 to the wireless access network 108.

In one embodiment, the CS 122 uses the transport interface 126 to schedule a content flow to be transmitted to the BBS 124 for broadcast/multicast over the wireless access network 108. For example, the content flow can comprise a non real-time content clip that was provided by the content provider 102 for distribution using the content provider network 104. In one embodiment, the CS 122 operates to negotiate with the BBS 124 to determine one or more parameters associated with the content clip. Once the BBS 124 receives the content clip, it broadcasts/multicasts the content clip over the wireless access network 108 for reception by one or more of the devices 110. Any of the devices 110 can be authorized to receive the content clip and cache it for later viewing by the device user.

For example the device 110 comprises a client program 132 that operates to provide a program guide that displays a listing of content that is scheduled for broadcast over the wireless access network 108. The device user can select to receive any particular content for rendering in real-time or to be stored in a cache 134 for later viewing. For example the content clip can be scheduled for broadcast during the evening hours, and the device 112 operates to receive the broadcast and cache the content clip in the cache 134 so that the device user can view the clip the next day. Typically, the content is broadcast as part of a subscription service and the receiving device may need to provide a key or otherwise authenticate itself to receive the broadcast. In one or more embodiments, the transport system allows the CS 122 to receive program-guide records, program contents, and other related information from content provider 102. The CS 122 updates and/or creates content for delivery to devices 110.

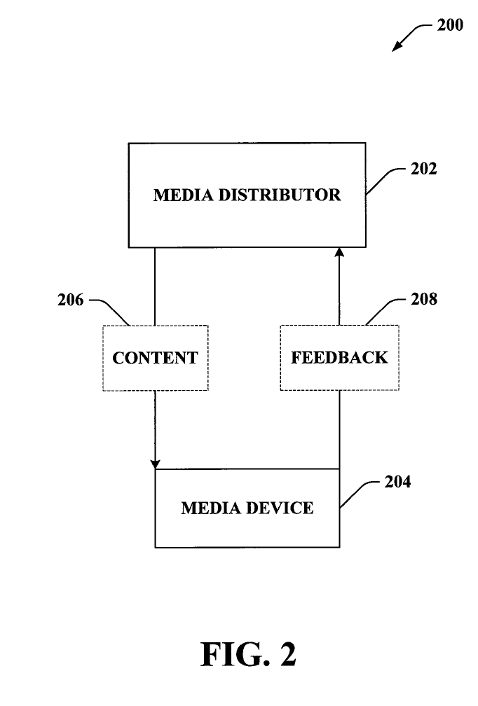

Referring to FIG. 2, illustrated is a system 200 that facilitates automatic generation of a broadcast schedule of content. The content can include video, audio, multimedia content, clips, real-time and non real-time content, scripts, programs, textual content, or other content capable of delivery via a communication medium. Pursuant to an illustration, the content can be broadcasted to a plurality of users such the users simultaneously perceive a particular point of a broadcasted stream at an identical time. It is to be appreciated that other delivery mechanisms can be employed. For example, a unicast and/or multicast delivery scheme can be utilized to deliver the schedule of content. A broadcast schedule of content can be, for instance, an order of content such that the content included on the schedule is delivered in the order specified. Pursuant to an illustration, a broadcast schedule can launch with a first program (e.g., piece of content). The first program can be broadcasted and/or streamed to completion prior to transmission of a next program on the broadcast schedule.

In accordance with an aspect, a broadcast schedule can be automatically generated based upon user feedback as provided in system 100. The system 100 can include a media distributor 202 that delivers content 206 to one or more recipients such as a media device 204. The media distributor 202 can similar to the content provider network 104 described with reference to FIG. 1. The media distributor 202 can distribute content to one or more media devices via a broadcast delivery mechanism. The media distributor 202 can obtain, organize, schedule and broadcast content from a plurality of content providers (not shown). The plurality of content providers can be originators and/or creators of content. In addition, the plurality of content providers can be sources or repositories of content from which the media distributor 202 can extract for transmission to media devices. Pursuant to an illustration, the media distributor 202 can be a cable media provider, a satellite media provider (e.g., satellite television, satellite radio, satellite communications, etc.), an over-the-air media provider (e.g., legacy television and radio networks), a wireless communication provider, an Internet server, a server on a local area network, or any other type of media provider that can distribute content to media devices via a communication medium.

The media distributor 202 can broadcast a schedule that includes content 206 to media device 204. The media device 204 can be, for instance, wireless communication apparatus (e.g., mobile device, access terminal, user equipment, and the like), a media appliance (e.g., television, radio, visual display, etc.), a computing device (e.g., laptop, personal computer, PDA, . . . ) and/or any other device capable of obtaining and presenting multimedia content to a user. The media device 204 can accept a broadcasted stream or transmission of content 206 that is ordered in accordance with a broadcast schedule. The broadcasted stream can be transmitted via a suitable communication link. For example, the media distributor can transmit via links such as but not limited to, a cable link, a satellite link, a wireless communication link, a data link and the like.

In accordance with an aspect, the media device 204 can provide feedback 208 to the media distributor 202. However, it is to be appreciated that other computing devices can be utilizes to provide feedback. For instance, a user can log in to a web site offered by a content provider and/or media distributor 204 via a suitable computing device and provide feedback via the web site. The media distributor 204 can employ the feedback 208 to automatically determine a schedule of content to broadcast. In addition, the media distributor 204 can utilize the feedback 208 to adjust or alter a schedule of content currently transmitting. Pursuant to an illustration, the feedback 208 can be ratings, comments, reviews, critiques, interest indicators, and the like. According to another illustration, the feedback can also be a schedule. For example, users can generate a wish list schedule or a schedule developed to their preferences. The media distributor 204 can employ a variety of analysis mechanisms to generate broadcast schedules based upon feedback 208. For example, the media distributor can analyze feedback 208 to determine popular content and determine a broadcast schedule in which the popular content is delivered more frequently. While system 200 depicts a single media device, it is to be appreciated that a plurality of media devices can be employed in system 200 to receive broadcasted content and/or provide feedback to the media distributor 204 to influence schedule generation.

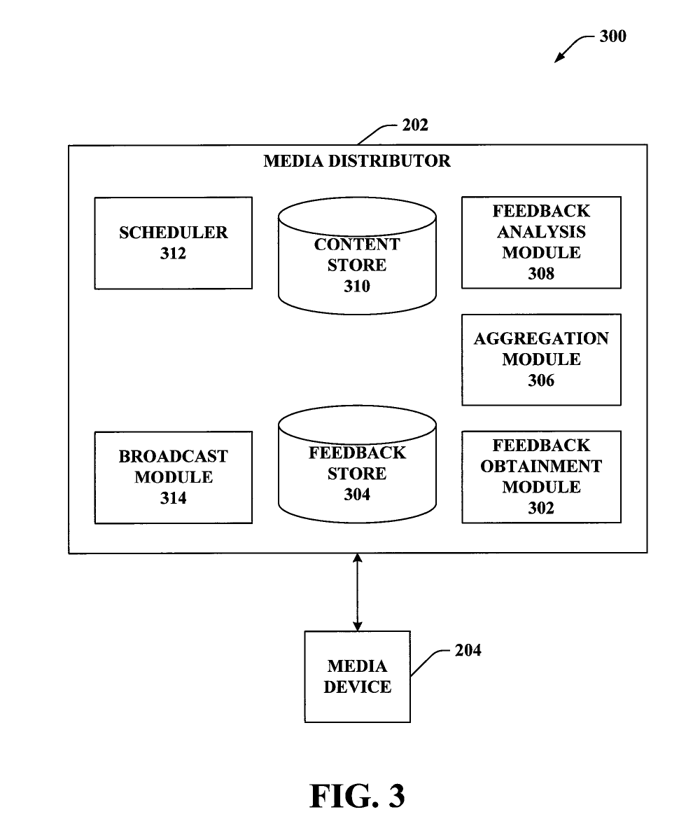

Turning now to FIG. 3, illustrated is a system 100 that facilitates generation of broadcast schedules based on user feedback. The system 300 can include the media distributor 202 and the media device 204 as described supra with reference to FIG. 2. The media distributor 202 can deliver (e.g., broadcast) content to the media device 204 in accordance with a broadcast schedule. The broadcast schedule can be automatically generated based upon feedback obtained from the media device 204 (and any other media devices (not shown)).

The media distributor 202 can include a feedback obtainment module 302 that can collect feedback supplied by the media device 204. It is to be appreciated that the feedback obtainment module 302 can further collect feedback from other media devices. The feedback can be ratings of content, reviews of content, comments on content, critiques on the content, or any other information that can express interest, popularity and/or recognition of content. The media distributor 202 can retain collected feedback in a feedback store 304. The media distributor 202 can also include an aggregation module 306 that can aggregate feedback collected by the feedback obtainment module 302 and/or retained in the feedback store 304. Pursuant to an example, the aggregation module 306 can aggregate ratings related to a particular program (e.g., portion of content) obtained from a plurality of users. For instance, the aggregation module 306 can determine a mean rating, a median rating or other statistical aggregate of disparate feedback information. Further, in addition to feedback collected by the feedback obtainment module 302, the feedback store 304 can retain aggregate or compiled feedback information produced by the aggregation module 306.

The media distributor 202 can also comprise a feedback analysis module 308 that can analyze feedback (e.g., aggregated feedback, disparate feedback, individual feedback, etc.) to determine popularity, widespread interest, and/or a collective significance of content. For example, the feedback analysis module 308 can ascertain a ranking of content. The ranking can be based upon popularity of content. For instance, the feedback analysis module 308 can list content from most popular to least popular. It is to be appreciated that the feedback analysis module 308 can employ various other statistical, inferential, and/or classification techniques on obtained feedback to ascertain relative importance or popularity of content.

The content for which feedback is obtained and analyzed can be retained in a content store 310. The content can be collected from one or more content providers (not shown). The media distributor 202 includes a scheduler 312 that automatically determines a broadcast schedule of content retained in content store 310 based at least in part on the feedback analysis. Pursuant to an illustrative embodiment, the scheduler 312 can schedule popular content, as determined by the feedback analysis module 308, more frequently and/or at a prime time. The media distributor 202 can further include a broadcast module 314 that facilitates broadcast or transmission of the schedule generated by the scheduler 312. The broadcast module 314 can deliver the content stream to media device 204 or any other device capable of receiving the content stream. In addition, it is to be appreciated that the media distributor 202 can employ encryption mechanisms such that the content stream is indecipherable to media devices not associated with a subscription or with other rights tied to the content.

It is to be appreciated that the content store 310 and/or feedback store 304 described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The content store 310 and the feedback store 304 of the subject systems and methods is intended to comprise, without being limited to, these and any other suitable types of memory. In addition, it is to be appreciated that the content store 310 and feedback store 304 can be servers, databases, hard drives, pen drives, external hard drives, portable hard drives and the like.

It is to be appreciated that the media distributor 202 can include any suitable and/or necessary interfaces (not shown), which provide various adapters, connectors, channels, communications paths, etc., to integrate the feedback obtainment module 302, the feedback store 304, the aggregation module 306, the feedback analysis module 308, the content store 310, the scheduler 312 and the broadcast module 314 into virtually any application, operating and/or database system(s) and/or with one another. In addition, the interfaces can provide various adapters, connectors, channels, communications paths, etc., that enable interaction between the various modules and stores described above. Further, it is to be appreciated and understood that the feedback obtainment module 302, the feedback store 304, the aggregation module 306, the feedback analysis module 308, the content store 310, the scheduler 312 and the broadcast module 314 each can be a stand-alone unit (as depicted), can be incorporated within another component or module, and/or virtually any suitable combination thereof, as desired.

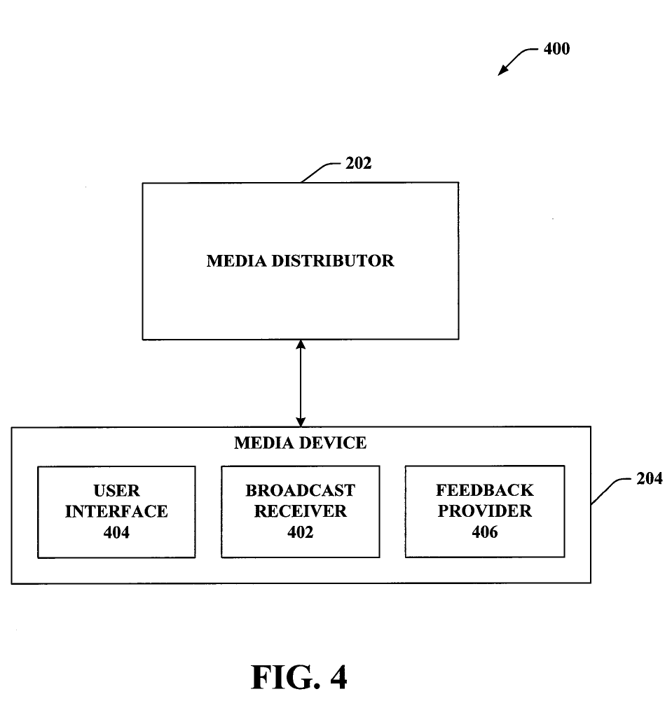

FIG. 4 illustrates a system 400 that facilitates providing feedback to a media distributor that can be utilized to automatically generate a broadcast schedule. The system 400 can include the media distributor 202 and the media device 204 as described supra with reference to FIG. 2 and FIG. 3. The media distributor 202 can deliver (e.g., broadcast) content to the media device 204 in accordance with a broadcast schedule. The broadcast schedule can be automatically generated based upon feedback obtained from the media device 204 (and any other media devices (not shown)).

The media device 204 can include a broadcast receiver 402 that can obtain a broadcasted transmission or stream of content from the media distributor 202. For example, the broadcast receiver 402 can receive broadcast content from a variety of networks such as, but not limited to, a wireless communication network, a cable network, a satellite network, a data network (e.g., the Internet, an intranet, a LAN, a WAN, etc.) and or any suitable network via which content can be delivered. In addition, the broadcast receiver 402 can facilitate authentication and/or authorization between the media device 204 and the media distributor 202 to enable receival and/or deciphering of the broadcasted stream of content.

The media device 204 can further include a user interface 404 that can collect input information from a user, solicit information from the user and/or provide output information to the user. The input information can be, for example, interactions of a user with the user interface 404 via an input device (not shown) such as, but not limited to, a tablet and pen, a touch screen, a mouse, a touch pad, a track ball, keys, buttons and/or any other suitable device capable of receiving and/or soliciting user interaction with respect to an interface. In addition, the user interface 404 can include user interface (UI) controls. Pursuant to an illustration, the UI controls can be manipulated by an input device to gather, solicit and/or receive input information from a user. UI controls are interface elements utilized by a user to interact with a computing environment. UI controls can include graphical objects such as, but not limited to, a button, a check box, a text box, a text label, a slider, a list box, a spinner, a drop-down list, a menu, a toolbar, a toolbar icon, a ribbon, a combo box (i.e., a text box with attached menu or list box), an icon, a tree view, a grid view, a tab, a scrollbar, a status bar, a progress bar and/or any other element capable of facilitating user interaction. In addition, UI controls can include interface elements that are collections of other interface elements. For example, UI controls can include windows, dialog boxes, palette windows, drawers, heads-up displays and the like. UI controls can be employed to generate a graphical user interface (GUI) provided by the user interface 404.

In an aspect, the media device 204 can obtain a listing of content available for broadcast from the media distributor 202. The listing can include summaries of content, portions of content, the content itself and/or any suitable information that enables a user to identify and evaluate content. In an illustrative embodiment, the listing can be provided via a web site. In addition, the listing can be downloaded and/or uploaded to the media device 202 and displayed to a user via the user interface 404. A user of media device 204, via the user interface 404, can provide feedback associated with available content included on the listing. For example, the user can rate (e.g., provide a rating from 1 to 5, 1 to 10, a number of stars, etc.) content on the listing. In addition, the user can supply comments, reviews, critiques and the like on content on the listing. Further, the user can supply a user schedule (e.g., a wish list) of content.

The media device 204 can include a feedback provider 406 that can transmit feedback, supplied from a user via the user interface 404, to the media distributor 202. The feedback can be transmitted on an uplink path associated with a downlink path on which content is broadcasted. For example, content can be broadcasted via downlink or forward link channels of a wireless communication network and feedback can be transmitted on an uplink or reverse link channel. In addition, the feedback can be provided on a communication path disparate from the broadcast medium. For instance, content can be broadcasted via satellite and feedback can be transmitted via the Internet, among other mediums. After delivery of feedback to the media distributor 202, a broadcast schedule can be automatically generated in accordance with the feedback (and any other feedback aggregated from a plurality of media devices).

It is to be appreciated that the media device 204 can include any suitable and/or necessary interfaces (not shown), which provide various adapters, connectors, channels, communications paths, etc., to integrate the broadcast receiver 402, the user interface 404, and the feedback provider 406 into virtually any application, operating and/or database system(s) and/or with one another. In addition, the interfaces can provide various adapters, connectors, channels, communications paths, etc., that enable interaction between the various modules and stores described above. Further, it is to be appreciated and understood that the broadcast receiver 402, the user interface 404, and the feedback provider 406 each can be a stand-alone unit (as depicted), can be incorporated within another component or module, and/or virtually any suitable combination thereof, as desired.

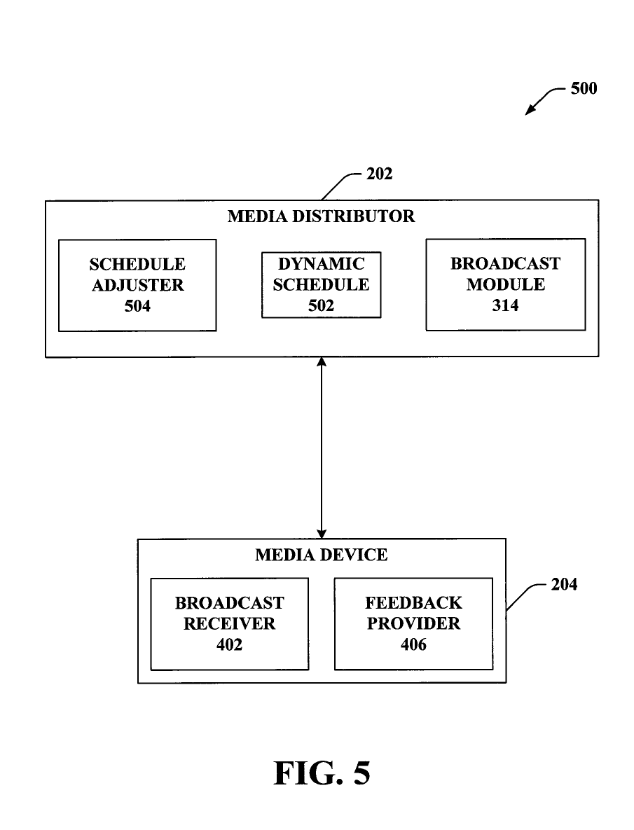

Referring to FIG. 5, a system 500 is depicted that facilitates adjusting broadcasts based upon contemporaneous feedback. The system 500 includes a media distributor 202 that can broadcast content, via a broadcast module 314, to a media device 204 based upon a dynamic schedule 502. The dynamic schedule 502 can be an automatically generated schedule such as for instance, the automatically generated schedules as described above with relation to systems 200, 300 and 400. In addition, the dynamic schedule 502 can be a broadcast schedule configured manually.

The media device 204 can include a broadcast receiver 402 that can receive (e.g., decipher, digest, process, . . . ) a broadcasted content stream from media distributor 202. For instance, the broadcast receiver 402 can obtain a content stream transmitted in accordance with the dynamic schedule 502. In addition, the media device 204 can include a feedback provider 406 that can supply contemporaneous feedback to the media distributor 202 related to a broadcasting content stream. The contemporaneous feedback can be feedback associated with a content program and provide concurrently or simultaneously with broadcasting and reception of the content program. The contemporaneous feedback can indicate an interest or disinterest in the content program. For instance, if a user receiving the broadcasted content stream is not interested in a content program streamed at a particular time, the user can indicate that disinterest (e.g., vote to stop the program) via contemporaneous feedback provided when the program is streamed at its scheduled time. It is to be appreciated that limits can be imposed on the media device 204 regarding contemporaneous feedback. For example, a media device 204 can provide a single vote per day, per program, and so on.

The media distributor 304 can include a schedule adjuster 504 that can alter the dynamic schedule during broadcast. Pursuant to an aspect, the schedule adjuster 504 can make changes or alterations to an ongoing broadcast schedule (e.g., dynamic schedule 502) based upon contemporaneous feedback obtained from the media device 204 (and any other media devices (not shown)). The schedule adjuster 504 can determine to halt broadcast of a particular content program and proceed to broadcast a next program as specified in the dynamic schedule 502. In addition, the schedule adjuster 504 can select another program from a set of available content (e.g., content store 310) to replace the halted content program. Pursuant to an illustration, the schedule adjuster 504 can ascertain whether or not to halt a broadcast according to a threshold value. For example, the schedule adjuster 504 can stop broadcast of a content program if a certain number of votes to halt are obtained from users and/or a scaled value of total number of votes collected (e.g., number of votes divided by 100 exceeds a threshold value). In addition, the threshold can be based on a percentage value of feedback received. In an illustrative example, a program can be halted if at least 51% of users providing feedback vote to stop broadcast. It is to be appreciated that any suitable threshold value can be employed and/or configured.

In another aspect, the media distributor 202 can notify users (e.g., media device 204 and any other devices) of changes made to the dynamic schedule 502 by the schedule adjuster 504. In addition, the media distributor 202 can make a halted content program available to those who desire to continue viewing. For example, the media distributor 202 can broadcast the content program on another channel, stream via a data network (e.g., the Internet), via a web and the like. The media distributor 202 can indicate where the halted content program can be viewed for users who would link to continue to do so.

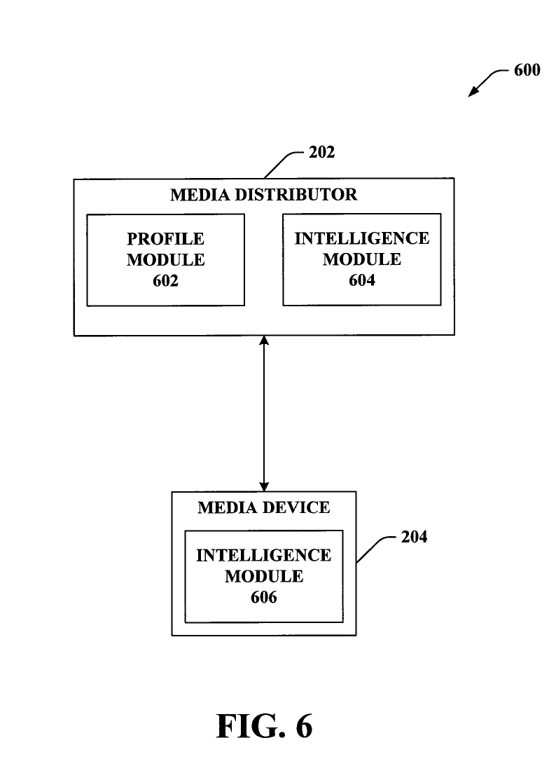

Turning now to FIG. 6, illustrated is a system 600 that employs intelligence to automatically generate broadcast scheduled based on supplied feedback. The system 600 can include the media distributor 202 and the media device 204 as described in previous figures. In addition, the media distributor 202 can include a profile module 602 that can facilitates employing user profiles in conjunction with obtaining feedback, analyzing feedback, generating schedules and so on. Users can create user profiles with the media distributor 202 and access the profiles and/or interact with the media distributor 202 according to profiles. For instance, a user can have a user account with media distributor 202 that enables the user to receive a broadcast (e.g., authorization to decipher a stream, to access the stream, etc.). The user account can include a user profile that retains information about the user such as a user name, password, past feedback, historical data, and/or a role within the system 600. The role can identify a user according to a variety of criteria. For instance, the role can indicate a level or degree of interaction a particular user has previously had with the media distributor 202 based in part on amount of feedback obtained fro the user. In addition, a role can specify a level of expertise of a user. For example, a user can be a media critic and, thus, viewed as having expertise in judging content for value.

In an aspect, the media distributor 202 can employ profiles to facilitate automatic generation of broadcast schedules. Pursuant to an illustration, the media distributor 202 can provide weightings to feedback based upon user profiles. For instance, a user who frequently provides feedback can receive a greater weight than a user that rarely supplies feedback. In addition, the media distributor 202 can give greater credence to feedback from expert users such as media critics.

The media distributor 202 can further include an intelligence module 604. The intelligence component 604 can facilitate aggregating feedback from users, analyzing feedback from users, determining patterns within the feedback, generating schedules, determining is a next program threshold is achieved, providing weightings to feedback and the like. In addition, the media device 204 can include an intelligence module 606 that facilitates supplying feedback, inferring user intention to automatically generate feedback according to historical user interaction, sending a vote to stop a broadcasting content program and the like. Moreover, it is to be understood that the intelligence modules 604 and 606 can provide for reasoning about or infer states of the system, environment, and/or user from a set of observations as captured via events and/or data.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, . . . xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

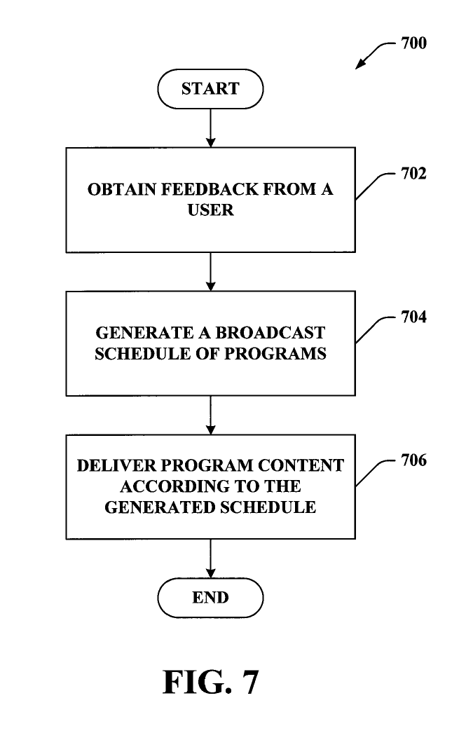

Referring to FIGS. 7-9, methodologies relating to automatically generating and/or altering a broadcast schedule based upon user feedback are described. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 7, illustrated is a methodology 700 that facilitates generating a schedule of broadcast programs according to obtained feedback. In one example, the method 700 can be employed by a media or content distributor and/or a content provider to deliver broadcasted content automatically determined by user (e.g., viewer) feedback. At reference numeral 702, feedback can be obtained from a user. It is to be appreciated that feedback can be further obtained from a plurality of users. For example, feedback can be collected from any user perceiving or desiring to perceive content that can be broadcasted on a distribution network. The feedback can include ratings, votes, comments, reviews, critiques and the like. Further, the feedback can be provided relative to individual content items (e.g., content programs, broadcast programs, etc.) and/or related to a group of content items.

At reference numeral 704, a broadcast schedule of programs (e.g., pieces of individual content) can be generated. The schedule can be constructed from a list of available content in accordance with the obtained feedback. For example, the feedback can indicate popularity of content and most popular content can be schedule for broadcast frequently and/or at a prime time slot. The scheduled can be determined based upon analysis of obtained feedback to determine popularity, widespread internet and the like. In addition, feedback can be aggregated to facilitate analysis. At reference numeral 706, program content can be delivered to a user according to the generated schedule. In accordance with another illustration, the schedule generation can be dynamic and on-going such that the schedule is frequently updated to reflect latest feedback obtained. Schedule generation can also be periodic such that a schedule, once created, cannot be altered. For instance, feedback analysis can be frozen some time period (e.g., upon reaching a threshold) before generation and/or delivery of a broadcast schedule. For example, feedback obtained on any particular day can only influence generation of a schedule for the following day at the earliest.

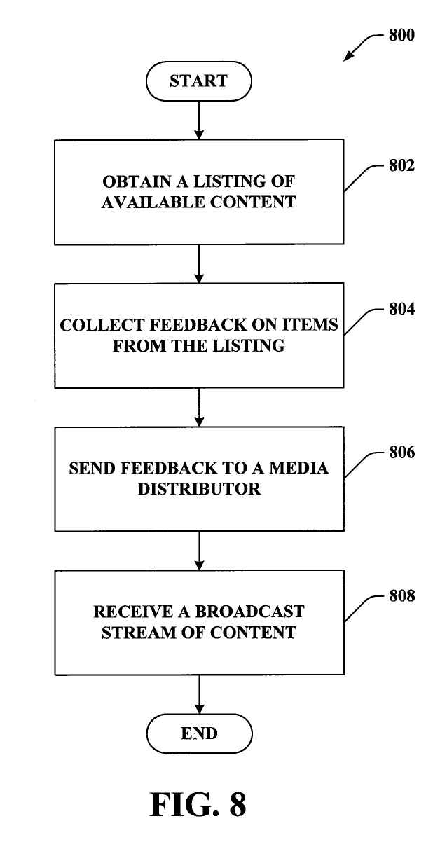

Referring to FIG. 8, a methodology 800 is illustrated that facilitates receiving a broadcast determined from supplied feedback. In one example, the method 700 can be employed by a media or content device and/or user equipment to receive broadcasted content that is influenced by user feedback. At reference numeral 802, a listing of available content is obtained. The listing can be, for example, a web page. At reference numeral 804, feedback on items form the listing is collected and/or solicited. For instance, an interface can be provided that displays the listing and enables ratings, votes, comments, reviews, etc., to be entered by a user. At reference numeral, 806, the collected feedback can be sent to a media distributor, content distributor and/or content provider. The media distributor can utilize the feedback to automatically generate a broadcast schedule of content. At reference numeral 808, a broadcast stream of content can be received. For instance, the broadcasted stream can be based upon a schedule developed in accordance with the transmitted feedback.

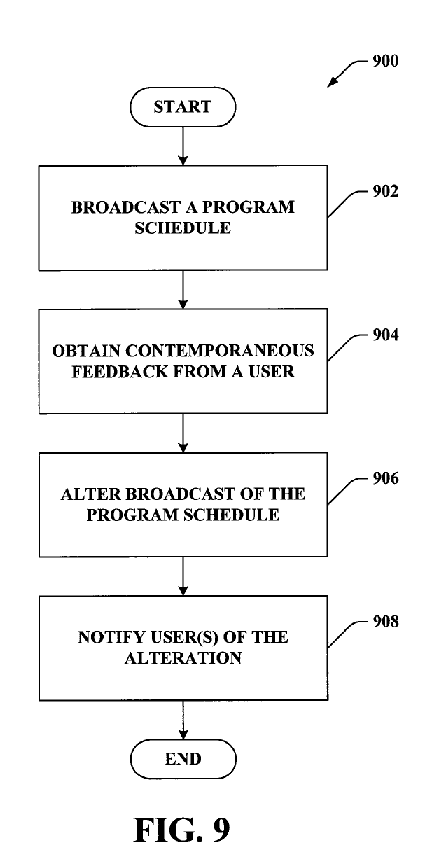

Turning now to FIG. 9, illustrated is a methodology 900 that facilitates dynamically altering a broadcast schedule according to contemporaneous information. At reference numeral 902, a program schedule of content can be broadcasted. The program schedule can be manually configured schedule or an automatically generated schedule as described herein with reference to FIGS. 2-8. At reference numeral 904, contemporaneous feedback from a user can be obtained. The contemporaneous feedback can be collected and/or provided simultaneously or concurrently with a program being broadcasted in accordance with the program schedule. In addition, the contemporaneous feedback can be related to the currently playing content. Further, the contemporaneous feedback can in the form of a vote that indicates whether or not to continue broadcasting the currently playing program.

At reference numeral 906, the program schedule and/or the broadcast thereof can be altered. Pursuant to an illustration, an alteration can be determined based upon collected contemporaneous feedback. For example, if contemporaneous feedback collected from one or more users reaches a threshold (e.g., number of votes, percentage of votes, etc.), then broadcast of a currently playing program, corresponding to the feedback, can be halted. At reference numeral 908, users can be notified of the alteration. In addition, alternative means can be provided with which users can continue to receive the halted content. For example, the halted content can be broadcasted on a separate channel, streamed via the Internet, made available for download or purchase and the like.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

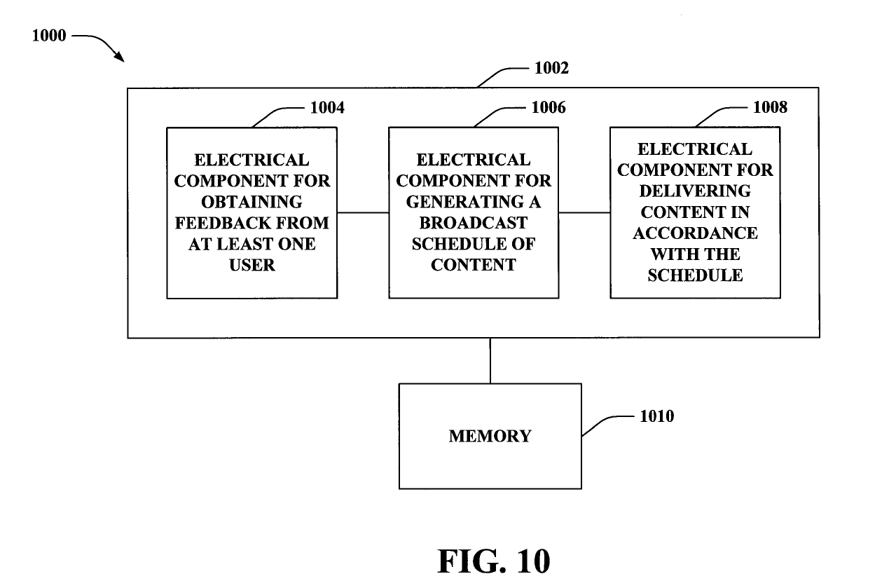

With reference to FIG. 10, illustrated is a system 1000 that generates broadcast schedules according to user feedback. For example, system 1000 can reside at least partially within a content provider, media distributor, media device, content device, client device, computing device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include an electrical component for obtaining feedback from at least one user 1004. Further, logical grouping 1002 can comprise an electrical component for generating a broadcast schedule of content 1006. Moreover, logical grouping 1002 can comprise an electrical component for delivering content in accordance with the schedule 1008. For example, registration with the mobile device can be based at least in part on a round trip time required to transmit and receive the at least one ping message and the return message. Additionally, system 1000 can include a memory 1010 that retains instructions for executing functions associated with electrical components 1004, 1006, and 1008. While shown as being external to memory 1010, it is to be understood that one or more of electrical components 1004, 1006, and 1008 can exist within memory 1010.

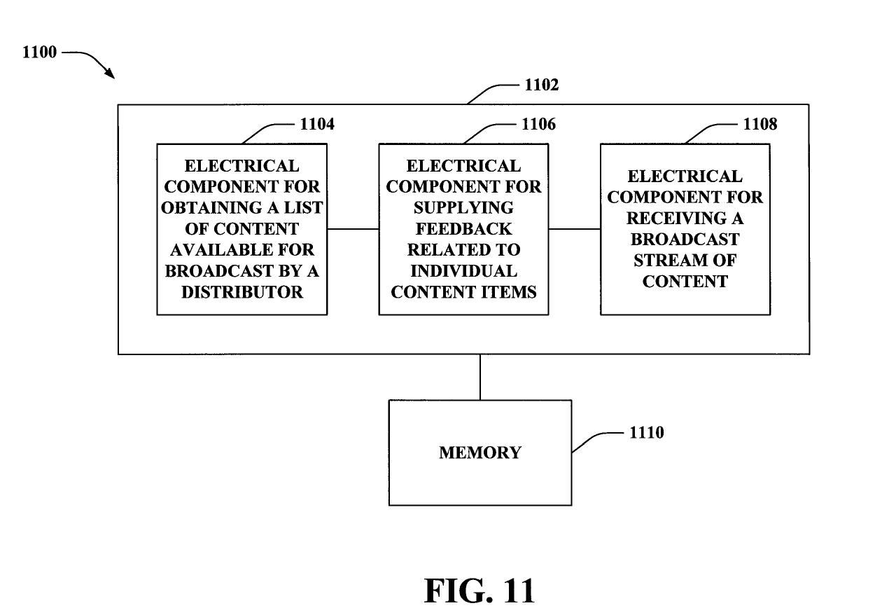

FIG. 11 illustrates a system 1100 that enables feedback to be supplied determines a broadcast schedule. For example, system 1100 can reside at least partially within a content provider, media distributor, media device, content device, client device, computing device, etc. It is to be appreciated that system 1100 is represented as including functional blocks, which can be functional blocks that represent functions implemented by a processor, software, or combination thereof (e.g., firmware). System 1100 includes a logical grouping 1102 of electrical components that can act in conjunction. For instance, logical grouping 1102 can include an electrical component for obtaining a list of content available for broadcast by a distributor 1104. Further, logical grouping 1102 can comprise an electrical component for supplying feedback related to individual content items 1106. Moreover, logical grouping 1102 can comprise an electrical component for receiving a broadcast stream of content 1108. For example, registration with the mobile device can be based at least in part on a round trip time required to transmit and receive the at least one ping message and the return message. Additionally, system 1100 can include a memory 1110 that retains instructions for executing functions associated with electrical components 1104, 1106, and 1108. While shown as being external to memory 1010, it is to be understood that one or more of electrical components 1104, 1106, and 1108 can exist within memory 1110.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates automatic content scheduling, comprising:
obtaining feedback from at least one user, the feedback relates to one or more content available for broadcast;
generating a broadcast schedule of content based at least in part on the obtained feedback; and
delivering content in accordance with the generated schedule.

2. The method of claim 1, further comprising creating a list of available content accessible by the at least one user.

3. The method of claim 1, further comprising aggregating feedback obtained from the at least one user.

4. The method of claim 3, wherein aggregating feedback includes at least one of computing an average of the feedback, computing a median of the feedback, or correlating the feedback.

5. The method of claim 1, further comprising analyzing the obtained feedback to determine at least one of popularity of content, widespread interest of content or a collective significance of content.

6. The method of claim 1, further comprising weighting obtained feedback in accordance with user profiles associated with the at least one user.

7. The method of claim 6, wherein weighting feedback comprises determining weights based upon user profile classifications established via classifiers.

8. The method of claim 7, wherein the user profile classifications are retained in the user profiles.

9. The method of claim 6, wherein the user profile retain information related to past feedback, frequency of past feedback and a role of a user that indicates a level of expertise.

10. The method of claim 1, further comprising receiving contemporaneous feedback during delivery of content wherein the contemporaneous feedback relates to currently playing content.

11. The method of claim 10, wherein the contemporaneous feedback comprise a vote that indicates one of a desire to stop broadcast of currently playing content or a desire to continue broadcast of currently playing content.

12. The method of claim 10, further comprising:
analyzing contemporaneous feedback relative to a threshold parameter; and
halting delivery of currently playing content if the threshold parameter is met.

13. The method of claim 12, further comprising replacing currently playing content with other content.

14. The method of claim 13, further comprising notifying the at least one user of the halted delivery.

15. The method of claim 13, further comprising providing halted content to the at least one user via a separate distribution path.

16. The method of claim 1, wherein delivering content comprises broadcasting content.

17. The method of claim 1, further comprising identifying a threshold such that feedback analysis is frozen and a static schedule is generated upon reaching the threshold.

18. An apparatus that facilitates content schedule generation, comprising:
a memory that retains instructions related to obtaining feedback from at least one user such that the feedback relates to one or more content available for broadcast, generating a broadcast schedule of content based at least in part on the obtained feedback and delivering content in accordance with the generated schedule; and
a processor, coupled to the memory, configured to execute the instructions retained in the memory.

19. The apparatus of claim 18, the memory further retains instructions related to creating a list of available content accessible by the at least one user.

20. The apparatus of claim 18, the memory further retains instructions related to aggregating feedback obtained from the at least one user.

21. The apparatus of claim 20, wherein instructions related to aggregating feedback includes instructions related to at least one of computing an average of the feedback, computing a median of the feedback, or correlating the feedback.

22. The apparatus of claim 18, the memory further retains instructions related to analyzing the obtained feedback to determine at least one of popularity of content, widespread interest of content or a collective significance of content.

23. The apparatus of claim 18, the memory further retains instructions related to weighting obtained feedback in accordance with user profiles associated with the at least one user.

24. The apparatus of claim 23, wherein the user profile retain information related to past feedback, frequency of past feedback and a role of a user that indicates a level of expertise.

25. The apparatus of claim 18, the memory further retains instructions related to receiving contemporaneous feedback during delivery of content wherein the contemporaneous feedback relates to currently playing content.

26. The apparatus of claim 25, wherein the contemporaneous feedback comprise a vote that indicates one of a desire to stop broadcast of currently playing content or a desire to continue broadcast of currently playing content.

27. The apparatus of claim 25, the memory further retains instructions related to:
analyzing contemporaneous feedback relative to a threshold parameter; and
halting delivery of currently playing content if the threshold parameter is met.

28. The apparatus of claim 27, the memory further retains instructions related to replace currently playing content with other content.

29. The apparatus of claim 28, the memory further retains instructions related to notifying the at least one user of the halted delivery.

30. The apparatus of claim 28, the memory further retains instructions related to providing halted content to the at least one user via a separate distribution path.

31. An apparatus that facilitates automatic generation of content broadcast schedules, comprising:
means for obtaining feedback from at least one user, the feedback relates to one or more content available for broadcast;
means for generating a broadcast schedule of content based at least in part on the obtained feedback; and
means for delivering content in accordance with the generated schedule.

32. A computer program product, comprising:
a computer-readable medium comprising:
code for causing a computer to obtain feedback from at least one user, the feedback relates to one or more content available for broadcast;
code for causing the computer to generate a broadcast schedule of content based at least in part on the obtained feedback; and
code for causing the computer to deliver content in accordance with the generated schedule.

33. At least one processor configured to:
obtain feedback from at least one user, the feedback relates to one or more content available for broadcast;
generate a broadcast schedule of content based at least in part on the obtained feedback; and
deliver content in accordance with the generated schedule.

34. A method that facilitates influence on a broadcast schedule, comprising:
obtaining a list of content available for broadcast by a distributor;
supplying feedback related to individual content items included on the list of content; and
receiving a broadcast stream of content according to a schedule determined based upon the supplied feedback.

35. The method of claim 34, further comprising providing contemporaneous feedback on currently playing content from the broadcast stream.

36. The method of claim 35, wherein the contemporaneous feedback includes a vote to one of stop or continue broadcast.

37. An apparatus that facilitates content scheduling, comprising:
a user interface that presents a list of content available for broadcast by a distributor, the user interface further collects feedback from at least one user;
a feedback provider that transmits the collected feedback to the distributor; and
a broadcast receiver that receives a broadcasted stream of content delivered in accordance with a schedule generated based upon the transmitted feedback.

38. The apparatus of claim 37, the feedback provider further transmits contemporaneous feedback to the distributor.

39. The apparatus of claim 38, wherein the contemporaneous feedback comprises a vote to one of stop or continue broadcast.

40. An apparatus that facilitates content scheduling, comprising:
means for obtaining a list of content available for broadcast by a distributor;
means for supplying feedback related to individual content items included on the list of content; and
means for receiving a broadcast stream of content according to a schedule determined based upon the supplied feedback.

41. A computer program product, comprising:
a computer-readable medium comprising:
code for causing a computer to obtain list of content available for broadcast by a distributor;
code for causing the computer to supply feedback related to individual content items included on the list of content; and
code for causing the computer to receive a broadcast stream of content according to a schedule determined based upon the supplied feedback.

42. At least one processor configured to facilitate content scheduling, comprising:
a first module for obtaining a list of content available for broadcast by a distributor;
a second module for supplying feedback related to individual content items included on the list of content; and
a third module for receiving a broadcast stream of content according to a schedule determined based upon the supplied feedback.
